(19) United States
(12) Patent Application Publication
(10) Pub. No.: US 2015/0248262 A1
(43) Pub. Date: Sep. 3, 2015

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Yoshitaka Suzuki, Izu (JP)

(21) Appl. No.: 14/615,612

(22) Filed: Feb. 6, 2015

(30) Foreign Application Priority Data
Feb. 28, 2014 (JP) 2014-037631

(51) Int. Cl. G06F 3/12

(52) U.S. Cl. CPC G06F 3/1273; G06F 3/1236; G06F 3/1259; G06F 3/1285

(57) ABSTRACT

In accordance with one embodiment, an information processing apparatus, which is connected with a server, comprises a printer configured to form an image on a recording medium, an input device configured to input information, a log file to be uploaded to the server, a setting file which stores, for each log file, presence/absence of execution of uploading for each event, and a control section configured to acquire, if it is determined that the event has occurred, the category of the event that has occurred, retrieve the setting file with the acquired event, read the name of the log file for which presence of execution of the uploading in the event is detected, and then upload the log file specified with the log name to the server.

### CROSS-REFERENCE TO RELATED APPLICATION

This application is based upon and claims the benefit of priority from Japanese Patent Application No. 2014-037631, filed Feb. 28, 2014, the entire contents of which are incorporated herein by reference.

### FIELD

Embodiments described herein relate generally to an information processing apparatus and an information processing method.

### BACKGROUND

Conventionally, there is known an information processing apparatus, a so-called office or business oriented computer, specialized in information processing and printing processing of invoices and sales slips.

The information processing apparatus is equipped with an input/output device such as a display, a keyboard, a mouse and the like, and a printer capable of carrying out printing on a duplicate business form or ledger sheet. The display and the printer within these devices are integrally mounted on a main body.

The information processing apparatus described above is generally used in a stand-alone manner. However, there is a case in which the information processing apparatus is connected with an external server through a network. In this case, the information processing apparatus regularly uploads various log files to the server to confirm the business history or to investigate the cause of failure at the time the failure occurs.

The conventional information processing apparatus uploads a great number of files at a time, and thus, the waiting time of the user becomes longer.

### BRIEF DESCRIPTION OF THE DRAWINGS

FIG. 1 is a perspective view illustrating the appearance of an information processing apparatus according to an embodiment;

FIG. 2 is a diagram illustrating an example of network constitution of the information processing apparatus and a server;

FIG. 3 is a block diagram illustrating the constitution of the information, processing apparatus;

FIG. 4 is a diagram illustrating the data constitution of a setting file;

FIG. 5 is a diagram illustrating an example of a setting input screen;

FIG. 6 is a flowchart illustrating the uploading operations carried out by a control section of the information processing apparatus; and

FIG. 7 is a flowchart illustrating the setting file transmission operation.

### DETAILED DESCRIPTION

In accordance with one embodiment, an information processing apparatus, which is connected with a server, comprises a printer configured to form an image on a recording medium, an input device configured to input information, a log file to be uploaded to the server, a setting file which stores, for each log file, presence/absence of execution of uploading for each event, and a control section configured to acquire, if it is determined that the event has occurred, the category of the event that has occurred, retrieve the setting file with the acquired event, read the name of the log file for which presence of execution of the uploading in the event is detected, and then upload the log file specified with the log name to the server.

Hereinafter, one embodiment of the information processing apparatus and the information processing method is described in detail with reference to the accompanying drawings.

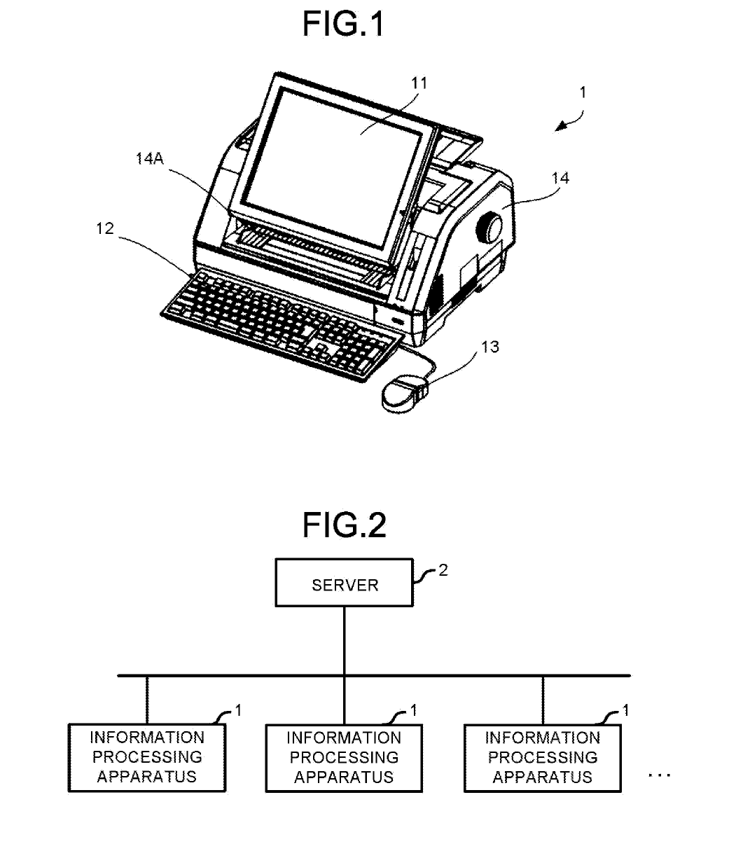

FIG. 1 is a perspective view illustrating the appearance of an information processing apparatus 1 according to one embodiment. As shown in FIG. 1, the information processing apparatus 1 is equipped with a printer 14 which forms an image on a recording medium, a display device 11 arranged integrally with the printer 14, and an input device such as a keyboard 12 or a mouse 13.

The printer 14 is provided with a paper insertion opening 14A arranged at the front side of the information processing apparatus 1 for inserting the recording medium, and a discharge opening (not shown) arranged at the back side of the display device 11 for discharging the recording medium. The information processing apparatus 1 in FIG. 1 is illustrated at the front side thereof.

The printer 14 includes an image forming section capable of carrying out printing on a duplicate business form. The image forming section may be, for example, an impact dot matrix head.

The image forming section may also be an electronic printer such as a laser printer, or an inkjet printer if a single business form is mainly used.

FIG. 2 is a diagram illustrating an example of network constitution of the information processing apparatus 1 and a server 2. As shown in FIG. 2, a plurality of information processing apparatuses 1 is respectively connected with one server 2 through a network.

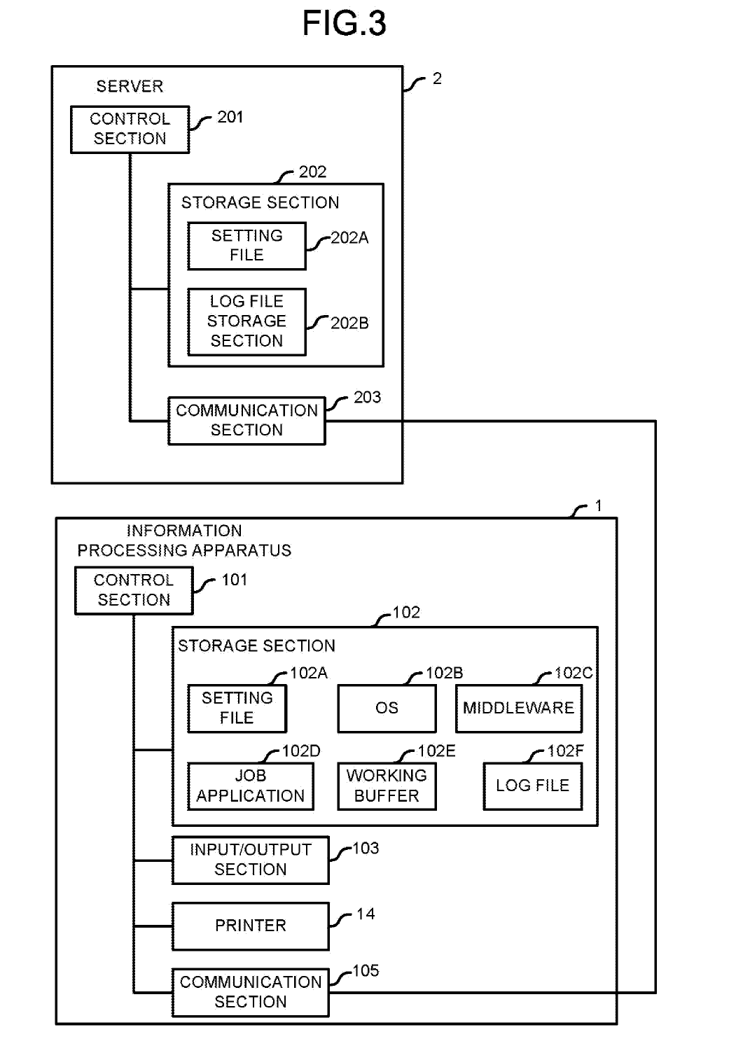

FIG. 3 is a block diagram illustrating the constitution of the information processing apparatus 1. As shown in FIG. 3, the information processing apparatus 1 is equipped with a control section 101 including a CPU (central processing unit) serving as an arithmetic device, a storage section 102 including a storage device such as a semiconductor memory and a hard disk drive, an input/output section 103 including input/output devices such as the display device 11, the keyboard 12 and the mouse 13, the printer 14, and a communication section 105 for carrying out communication.

The storage section 102 stores a setting file 102A for storing, for each log file 102F, presence/absence of execution of uploading for each event, an operating system (hereinafter referred to as an “OS”) 102B, a middleware 102C such as a menu program and a printer control program, a job application 102D for performing a specific job, a working buffer 102E serving as a work area, and a log file 102F.

The storage section 102 also stores information processing programs, and the control section 101 reads out the information processing programs from the storage section 102 to execute data processing in sequence.

An operator turns on the power source of the information processing apparatus 1 to launch the OS. The information processing apparatus 1 executes the job application 102D designated according to the instruction of the operator.

The communication section 105 is connected with a communication section 203 of the server 2 through a network.

The server 2 is equipped with a control section 201 including a CPU serving as an arithmetic device, a storage section 202 including a storage device such as a semiconductor memory and a hard disk drive, and the communication section 203 for carrying out communication.

The storage section 202 stores a setting file 202A, and a log file storage section 202B for storing the uploaded log file 102F.

The setting file 202A, which is used for delivery of data therein to the information processing apparatus 1 connected with the server 2, is identical in the data constitution with the setting file 102A.

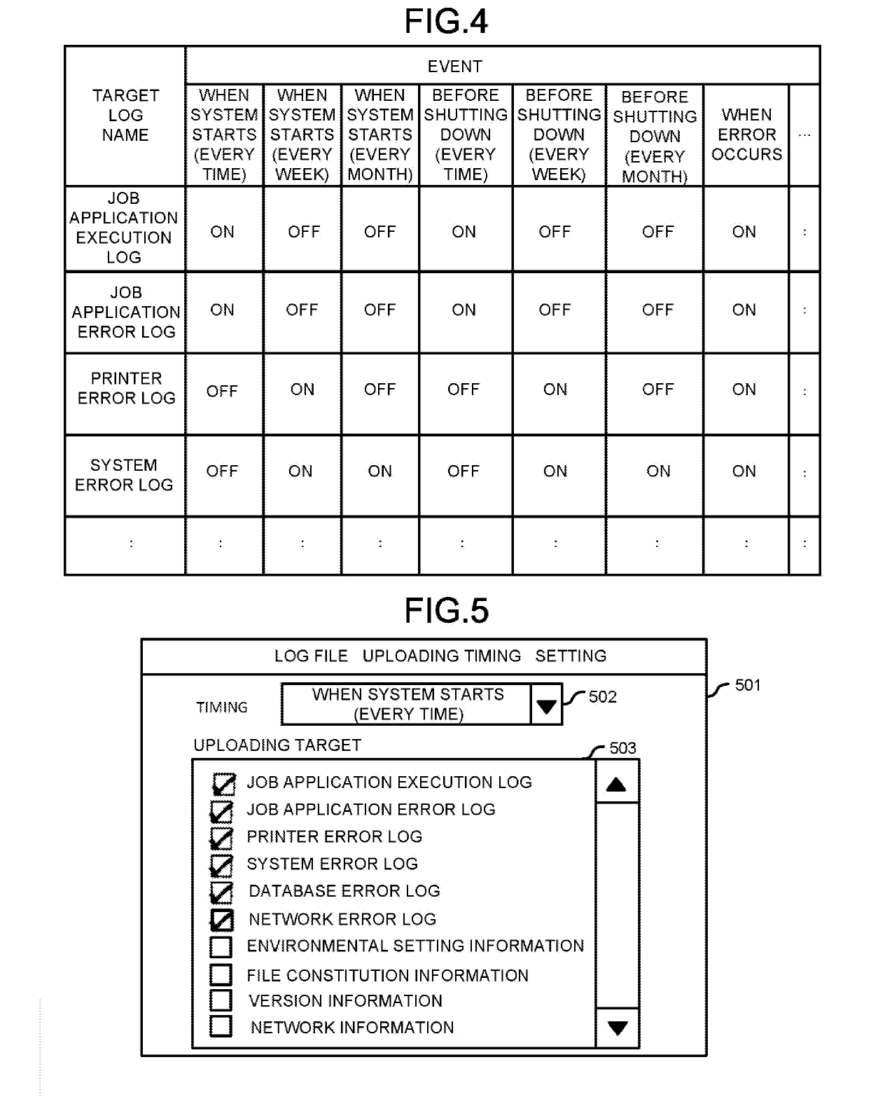

FIG. 4 is a diagram illustrating the data constitution of the setting file 102A. As shown in FIG. 4, the setting file 102A stores a “target log name” serving as the name of the log file 102F to be uploaded, and an “event” indicating the uploading timing.

The target log name includes, for example, a “job application execution log”, a “job application error log”, a “printer error log” and a “system error log”.

The event includes items respectively indicating the timing of sending the log file 102F, for example, “when system starts (every time)”, “when system starts (every week)”, “when system starts (every month)”, “before shutting down (every time)”, “before shutting down (every week)”, “before shutting down (every month)”, and “when error occurs”.

The setting file 102A stores information indicating whether or not the log file 102F is uploaded for each event. The setting file 102A stores an “ON” flag in a case of uploading the log file 102F, or stores an “OFF” flag in a case of not uploading the log file 102F.

An example of each data is as followings. In a case in which the target log name is “job application execution log”, as to the events, the flag is “ON” when system starts (every time), “OFF” when system starts (every week), “OFF” when system starts (every month), “ON” before shutting down (every time), “OFF” before shutting down (every week), “OFF” before shutting down (every month), and “ON” when error occurs. The “ON” and “OFF” flags can be set appropriately.

FIG. 5 is a diagram illustrating an example of a setting input screen 501. As shown in FIG. 5, the information processing apparatus 1 displays the setting input screen 501 for inputting the setting file 102A on the display device 11.

The setting input screen 501 displays a title “log file uploading timing setting”, and includes a timing input section 502 for selectively inputting an event through a pull-down menu, and an uploading target selection section 503 for selecting the name of the log file to be uploaded at the selected timing.

The log file name of the log file 102F to be uploaded is selected through, for example, check boxes.

As shown in FIG. 5, it is possible to set through the setting input screen 501 that one uploading target file is uploaded at a plurality of timings.

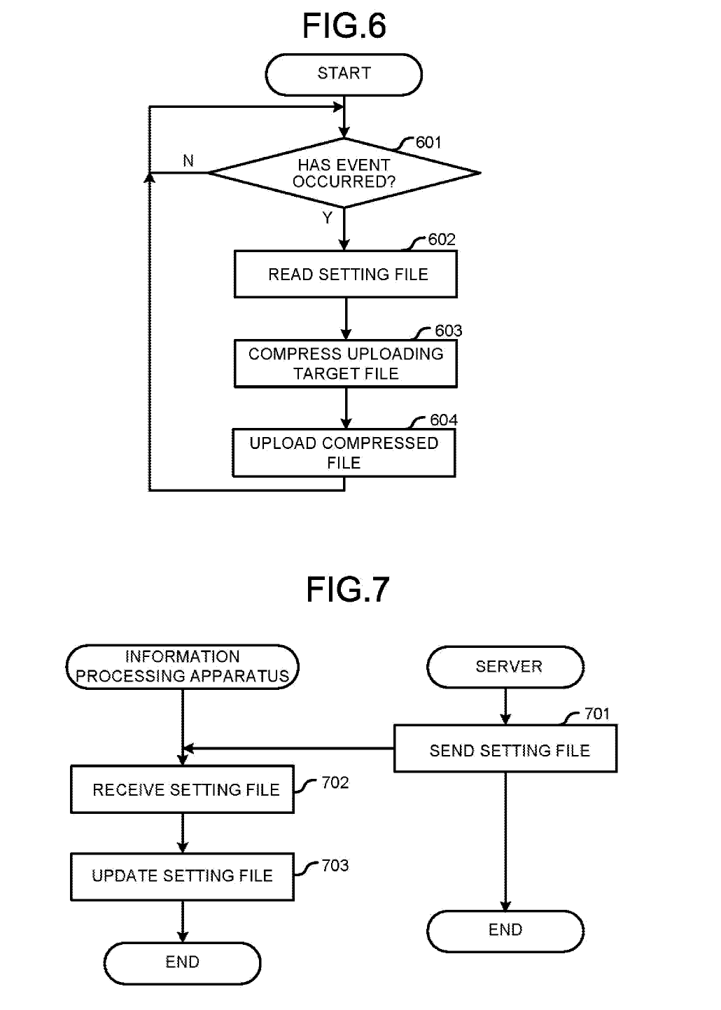

FIG. 6 is a flowchart illustrating the uploading operations of the control section 101 of the information processing apparatus 1. As shown in FIG. 6, in ACT 601, the information processing apparatus 1 determines whether or not the event has occurred. If it is determined that the event has occurred (YES in ACT 601), the information processing apparatus 1 acquires the category of the event from, for example, the OS 102B, and then the processing in ACT 602 is executed. If it is determined that the event does not occur (NO in ACT 601), the information processing apparatus 1 executes the processing in ACT 601 again.

In ACT 602, the information processing apparatus 1 retrieves the setting file 102A with the acquired event, and reads the target log name on which presence of the execution of uploading in the acquired event is detected (that is, “ON” flag is stored).

In ACT 603, the information processing apparatus 1 compresses the log file 102F specified with the read target log name to generate an archive file.

At this time, the information processing apparatus 1 can contain a client name and the file creation date and time in the file name of the archive file to make it unique in the log file storage section 202B.

Specifically, in a case in which the file name of the log file 102F to be uploaded is “CL-LOG”, the client name is “USER001”, and the file creation date and time is “20140305101523”, the information processing apparatus 1 can set the file name of the archive file to be “CL-LOG USER001 20140305101523.LZH”.

In ACT 604, the information processing apparatus 1 uploads the archive file to the server 2, and then the processing in ACT 601 is executed again.

In this way, through the uploading operation described above, the information processing apparatus 1 can upload only the designated log file 102F to the server 2 at the designated timing.

FIG. 7 is a flowchart illustrating the transmission operation of the setting file 102A. As shown in FIG. 7, the information processing apparatus 1 and the server 2 carry out the transmission operation by the control section 101 and the control section 201.

In ACT 701, the server 2 sends the setting file 202A to the information processing apparatus 1.

In ACT 702, the information processing apparatus 1 receives the setting file 202A from the server 2.

In ACT 703, the information processing apparatus 1 overwrites the setting file 102A in the storage section 102 with the received setting file 202A to update the setting file 102A.

In this way, the server 2 can collectively update the setting files 102A of the plurality of information processing apparatuses 1 connected through the network.

As stated above, the information processing apparatus 1 according to the present embodiment is equipped with the printer 14 for forming an image on the recording medium, the input device for inputting information, the log file 102F to be uploaded to the server 2, the setting file 102A for storing, for each log file 102F, presence/absence of execution of uploading for each event. The information processing apparatus 1 is also equipped with the control section 101 which acquires, if it is determined that the event has occurred, the category of the event, retrieves the setting file 102A with the acquired event, reads the target log name of the log file for which the presence of execution of uploading in the event is detected, and then compresses the log file 102F specified with the target log name to upload it to the server 2.

In this way, when log file is uploaded to the server, the waiting time of the user can be reduced.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus which is connected with a server, comprising:
a printer configured to form an image on a recording medium;
an input device configured to input information;
a log file to be uploaded to the server;
a setting file which stores, for each log file, presence/absence of execution of uploading for each event; and
a control section configured to acquire, if it is determined that the event has occurred, the category of the event that has occurred, retrieve the setting file with the acquired event, read the name of the log file for which presence of execution of the uploading in the event is detected, and then upload the log file specified with the log name to the server.

2. The information processing apparatus according to claim 1, wherein the control section compresses the log file and then uploads the compressed log file to the server.

3. The information processing apparatus according to claim 1, wherein the server sends the setting file in which the presence/absence of execution of uploading for each event is stored for each log file to the information processing apparatus, and the information processing apparatus updates the setting file stored therein with the setting file received from the server.

4. An information processing method by an information processing apparatus, connected with a server, which comprises a printer configured to form an image on a recording medium, an input device configured to input information, a log file to be uploaded to the server, and a setting file for storing, for each log file, presence/absence of execution of uploading for each event, including:
acquiring category of an event if it is determined that the event has occurred;
retrieving the setting file with the acquired event;
reading the name of the log file for which the presence of execution of uploading in the event is detected; and
uploading the log file specified with the log name to the server.

5. The information processing method according to claim 4, further including:
compressing the log file and then uploading the compressed log file to the server.

6. The information processing method according to claim 4, further including:
receiving the setting file sent from the server; and
updating the setting file stored in the information processing apparatus with the setting file received from the server.
